(19) United States
(12) Patent Application Publication
(10) Pub. No.: US 2010/0092714 A1
(43) Pub. Date: Apr. 15, 2010

(54) Pressure-Sensitive Adhesive Tape

(75) Inventors: Yuki Sugo, Ibaraki-shi (JP); Yoshio Terada, Ibaraki-shi (JP); Takashi Oda, Ibaraki-shi (JP); Hiroyuki Kondou, Ibaraki-shi (JP)

Correspondence Address: THE WEBB LAW FIRM, P.C., 700 KOPPERS BUILDING, 436 SEVENTH AVENUE, PITTSBURGH, PA, 15219, US

(73) Assignee: NITTO DENKO CORPORATION, Ibaraki-shi (JP)

(21) Appl. No.: 12/529,237

(22) PCT Filed: Feb. 18, 2008
(86) PCT No.: PCT/JP2008/052642

§ 371 Date: Aug. 31, 2009

(30) Foreign Application Priority Data
Mar. 6, 2007 (JP) 2007-054992

(51) Int. Cl. B32B 37/12

(52) U.S. Cl. 428/41.5

(57) ABSTRACT

Provided is a pressure-sensitive adhesive tape which has a sufficient pressure-sensitive adhesive strength for an adherend, is excellent in heat resistance, and can be easily peeled without leaving a pressure-sensitive adhesive residue on the adherend particularly upon peeling. The pressure-sensitive adhesive tape includes, on a substrate, a pressure-sensitive adhesive layer containing a lipophilic layered clay mineral, in which the layered clay mineral is in a state of being peeled and dispersed, and the interlayer distance of the layered clay mineral is 50 Å or more.

### TECHNICAL FIELD

The present invention relates to a pressure-sensitive adhesive tape, and more particularly, to a pressure-sensitive adhesive tape which has a sufficient pressure-sensitive adhesive strength for an adherend, is excellent in heat resistance, and can easily be peeled without leaving a pressure-sensitive adhesive residue on the adherend particularly upon peeling.

### BACKGROUND ART

The applications of a pressure-sensitive adhesive tape have been covering a broad spectrum in recent years. The pressure-sensitive adhesive tape has been used in a wide variety of fields such as the production of electronic parts, structures, and automobiles. Inmost of those applications, a large stress is applied to the pressure-sensitive adhesive tape at the time of the use of the pressure-sensitive adhesive tape, and the pressure-sensitive adhesive tape is used at high temperatures. Accordingly, a pressure-sensitive adhesive layer used in the pressure-sensitive adhesive tape is requested to have a high cohesive strength and heat resistance. Because the production of an electronic part, a semiconductor device, or a flat display such as an LCD or PDP involves a particularly large number of processes to be performed at high temperatures of 100° C. or higher, a pressure-sensitive adhesive tape having the following characteristics has been strongly requested: the pressure-sensitive adhesive tape exerts a sufficient pressure-sensitive adhesive strength and a sufficient cohesive strength at high temperatures, and can be easily peeled and removed from an adherend after its use.

However, a pressure-sensitive adhesive layer in a conventional pressure-sensitive adhesive tape involves problems that the layer is poor in pressure-sensitive adhesive strength and cohesive strength at high temperatures.

In view of the foregoing, investigations have been conducted on an improvement in heat resistance of the pressure-sensitive adhesive layer by the blending of the various inorganic fillers. For example, it has been reported that the pressure-sensitive adhesive layer shows an improved pressure-sensitive adhesive strength and an improved cohesive strength at high temperatures when a lipophilic layered clay mineral is used as an inorganic filler, and the lipophilic layered clay mineral is dispersed in the pressure-sensitive adhesive layer (see Patent Documents 1 and 2).

The above-mentioned approach involving dispersing the lipophilic layered clay mineral in the pressure-sensitive adhesive layer is an effective approach to improving the pressure-sensitive adhesive strength and cohesive strength of the pressure-sensitive adhesive layer at high temperatures. However, when the pressure-sensitive adhesive tape is peeled and removed from an adherend at the time of reworking or after the completion of a production process, the following problem arises: the pressure-sensitive adhesive layer containing the lipophilic layered clay mineral undergoes a cohesive failure to leave a pressure-sensitive adhesive residue (paste residue) on the adherend.

### Patent Document 1: JP 2005-344008 A

### Patent Document 2: JP 2005-154581 A

### DISCLOSURE OF THE INVENTION

### Problems to be Solved by the Invention

An object of the present invention is to provide a pressure-sensitive adhesive tape which has a sufficient pressure-sensitive adhesive strength for an adherend, is excellent in heat resistance, and particularly can be easily peeled without leaving a pressure-sensitive adhesive residue on the adherend upon peeling.

### Means for Solving the Problems

The inventors of the present invention have conducted investigations on a cause for the cohesive failure of a pressure-sensitive adhesive layer containing a lipophilic layered clay mineral when a pressure-sensitive adhesive tape is peeled and removed from an adherend. As a result, it has been found that the state of the layered structure of the lipophilic layered clay mineral in the pressure-sensitive adhesive layer largely influences on the cohesive failure when the pressure-sensitive adhesive tape is peeled and removed from an adherend.

Then, the inventors have conducted further investigations on such a layered structure of the lipophilic layered clay mineral in the pressure-sensitive adhesive tape that the cohesive failure can be alleviated when the pressure-sensitive adhesive tape is peeled and removed from an adherend. As a result, the inventors have found that the layered clay mineral is set in a state of being peeled and dispersed and the interlayer distance of the layered clay mineral is set to equal to or larger than a predetermined distance, thereby solving the problems. Thus, the present invention has been completed.

The pressure-sensitive adhesive tape of the present invention includes, on a substrate, a pressure-sensitive adhesive layer containing a lipophilic layered clay mineral, in which the layered clay mineral is in a state of being peeled and dispersed, and the interlayer distance of the layered clay mineral is 50 Å or more.

In a preferred embodiment, the layered clay mineral includes a smectite-based clay mineral and/or a mica-based clay mineral.

In a preferred embodiment, the pressure-sensitive adhesive layer includes an acrylic pressure-sensitive adhesive composition formed of a monomer composition mainly composed of an alkyl (meth)acrylate ester of an alkyl alcohol having 4 to 14 carbon atoms.

In a preferred embodiment, 0.1 to 20 parts by weight of the layered clay mineral are incorporated with respect to 100 parts by weight of the acrylic pressure-sensitive adhesive composition.

In a preferred embodiment, the pressure-sensitive adhesive layer includes a silicone-based pressure-sensitive adhesive composition.

In a preferred embodiment, 0.1 to 20 parts by weight of the layered clay mineral are incorporated with respect to 100 parts by weight of the silicone-based pressure-sensitive adhesive composition.

In a preferred embodiment, the pressure-sensitive adhesive tape is used in producing an electronic part.

### EFFECT OF THE INVENTION

According to the present invention, there can be provided a pressure-sensitive adhesive tape which has a sufficient pressure-sensitive adhesive strength for an adherend, is excellent in heat resistance, and particularly can be easily peeled without leaving a pressure-sensitive adhesive residue on the adherend upon peeling.

The above effect can be effectively expressed: in the pressure-sensitive adhesive tape including a pressure-sensitive adhesive layer containing a lipophilic layered clay mineral on a substrate, by allowing the layered clay mineral to be in a state of being peeled and dispersed, and setting the interlayer distance of the layered clay mineral to 50 Å or more.

### BEST MODE FOR CARRYING OUT THE INVENTION

A pressure-sensitive adhesive tape of the present invention has, on a substrate, a pressure-sensitive adhesive layer containing a lipophilic layered clay mineral. Any appropriate thickness can be adopted as the thickness of the pressure-sensitive adhesive layer. The thickness of the pressure-sensitive adhesive layer is preferably 2 to 50 μm.

Examples of the above adhesive layer include: an acrylic pressure-sensitive adhesive composition formed of a monomer composition mainly composed of an alkyl (meth)acrylate ester of an alkyl alcohol having 4 to 14 carbon atoms; and a silicone-based pressure-sensitive adhesive composition.

The content of the alkyl (meth)acrylate ester of an alkyl alcohol having 4 to 14 carbon atoms in the monomer composition as a raw material for the above acrylic pressure-sensitive adhesive composition is preferably 50 to 100 wt %, more preferably 70 to 100 wt %, still more preferably 80 to 100 wt %, still more preferably 85 to 100 wt %, still more preferably 90 to 100 wt %, still more preferably 95 to 100 wt %, particularly preferably 97 to 100 wt %, or most preferably 100 wt %. When the above content is less than 50 wt %, the pressure-sensitive adhesive tape may be unable to exert its pressure-sensitive adhesive strength sufficiently.

Examples of the alkyl (meth)acrylate ester of an alkyl alcohol having 4 to 14 carbon atoms include alkyl esters of acrylates or methacrylates each having an alkyl group such as a butyl group, an isobutyl group, a pentyl group, an isopentyl group, a hexyl group, a heptyl group, an octyl group, an isoctyl group, a nonyl group, an isononyl group, a decyl group, or an isodecyl group, and compounds in each of which a part of the alkyl group is substituted with a hydroxyl group.

The monomer composition as a raw material of the acrylic pressure-sensitive adhesive composition may include any other appropriate monomers other than the alkyl (meth)acrylate ester of an alkyl alcohol having 4 to 14 carbon atoms. Examples of the other monomers include polar group-containing, copolymerizable monomers. Examples of the polar group-containing, copolymerizable monomers include: unsaturated acids such as (meth)acrylic acid, itaconic acid, and 2-acrylamide propane sulfonate; and hydroxyl group-containing monomers such as 2-hydroxyethyl (meth)acrylate and 2-hydroxypropyl (meth)acrylate.

When the monomer composition as a raw material for the above acrylic pressure-sensitive adhesive composition contains the above alkyl (meth)acrylate ester of an alkyl alcohol having 4 to 14 carbon atoms and the above polar group-containing, copolymerizable monomer, a weight ratio between their contents is preferably 85 to 97/15 to 3, or more preferably 90 to 95/10 to 5. When the ratio deviates from the above range, the elongation of the pressure-sensitive adhesive tape may reduce, or the pressure-sensitive adhesive tape may be unable to obtain desired adhesiveness.

The above acrylic pressure-sensitive adhesive composition may contain a coupling agent. The coupling agent is effective in causing a filler having a polar group and a monomer to interact with each other. They may be used alone or in combination. The coupling agent has only to be selected as appropriate in consideration of, for example, compatibility, thickening property, and the presence or absence of gelation.

Any appropriate coupling agent can be adopted as the above coupling agent. A preferable example of the coupling agent is an organic silicon monomer having two or more different reactive groups in anyone of its molecules. One of the two reactive groups in each molecule of the organic silicon monomer is a reactive group that chemically bonds to an inorganic material, and the other is a reactive group that chemically bonds to an organic material. Examples of the reactive group that chemically bonds to an inorganic material include a methoxy group, an ethoxy group, and a silanol group. Examples of the reactive group that chemically bonds to an organic material include a vinyl group, an epoxy group, a methacryl group, an amino group, and a mercapto group.

Examples of the coupling agent include vinyl trichlorsilane, vinyl tris(β-methoxyethoxy)silane, vinyl triethoxysilane, vinyl trimethoxysilane, γ-methacryloxypropyl trimethoxysilane, β-(3,4-epoxycyclohexyl)ethyl trimethoxysilane, γ-glycidoxypropyl trimethoxysilane, γ-glycidoxypropylmethyl diethoxysilane, N-β-(aminoethyl)-γ-aminopropyl trimethoxysilane, N-β-(aminoethyl)-γ-aminopropylmethyl dimethoxysilane, γ-aminopropyl triethoxysilane, N-phenyl-γ-aminopropyl trimethoxysilane, γ-mercaptopropyl trimethoxysilane, γ-chloropropyl trimethoxysilane, γ-glycidoxypropyl triethoxysilane, γ-methacryloxypropylmethyl diethoxysilane, γ-methacryloxypropyl triethoxysilane, N-β-(aminoethyl)-γ-aminopropyl triethoxysilane, and γ-aminopropyl trimethoxysilane.

The content of the coupling agent is preferably 0.05 to 20 parts by weight, more preferably 0.1 to 10 parts by weight, or still more preferably 0.5 to 5 parts by weight with respect to 100 parts by weight of the above monomer composition. When the content is less than 0.05 part by weight, the coupling agent may be unable to exert its effect. When the content is 20 parts by weight or more, the pressure-sensitive adhesive layer may become vulnerable.

Any appropriate composition such as a commercially available silicone-based pressure-sensitive adhesive can be adopted as the above silicone-based pressure-sensitive adhesive composition. When the silicone-based pressure-sensitive adhesive composition is used, the heat resistance of the pressure-sensitive adhesive tape is high, and the storage modulus and pressure-sensitive adhesive strength of the pressure-sensitive adhesive tape at high temperatures easily become appropriate values.

The lipophilic layered clay mineral is obtained by subjecting a layered silicate mineral having an exchangeable cation in its crystal structure to a lipophilic treatment.

Any appropriate layered silicate mineral can be adopted as the layered silicate mineral. Examples of the above layered silicate mineral include: smectite-based clay minerals such as montmorillonite, saponite, hectorite, and stevensite; and mica-based clay minerals such as fluoro-tetrasilicic mica. They may be used alone or in combination; a mica-based clay mineral is preferably used because the pressure-sensitive adhesive tape can obtain good toughness.

The lipophilic layered clay mineral is preferably of a plate-like shape. In this case, the lipophilic layered clay mineral has a thickness of preferably about 0.1 to 10 nm, or more preferably 0.5 to 5 nm. In addition, the lipophilic layered clay mineral has a width of preferably 10 to 10,000 nm, more preferably 20 to 7,000 nm, or still more preferably 50 to 5,000 nm. The terms “thickness” and “width” as used herein each refer to an average length. The average length can be determined by actual measurement with an electron microscope (TEM) photograph. When the above width exceeds 10,000 nm, the elongation of the pressure-sensitive adhesive tape may reduce. When the width is less than 10 nm, a breaking stress for the pressure-sensitive adhesive tape may increase.

The above lipophilic layered clay mineral is preferably as follows: an exchangeable cation between layers is subjected to an ion exchange treatment with an organic cation or the like so that a gap between the layers may be made lipophilic.

The exchangeable cation is a metal ion present on the surface of the crystal layer of a layered silicate mineral, such as a sodium ion or a calcium ion. A lipophilic monomer cannot penetrate into a gap between layers of the layered silicate mineral because such an ion is hydrophilic. Accordingly, a good dispersed product cannot be obtained. In order that the monomer may be caused to penetrate into the gap between the layers, the exchangeable cation must be subjected to ion exchange with a lipophilic, cationic surfactant or the like.

Examples of the cationic surfactant include quaternary ammonium salts and quaternary phosphonium salts.

Examples of the quaternary ammonium salts include lauryl trimethyl ammonium salts, stearyl trimethyl ammonium salts, trioctyl ammonium salts, distearyl dimethyl ammonium salts, distearyl dibenzyl ammonium salts, and ammonium salts each having a substituted propylene oxide skeleton. They may be used alone or in combination.

Examples of the quaternary phosphonium salts include decyl triphenyl phosphonium salts, methyl triphenyl phosphonium salts, lauryl trimethyl phosphonium salts, stearyl trimethyl phosphonium salts, distearyl dimethyl phosphonium salts, and distearyl dibenzyl phosphonium salts. They may be used alone or in combination.

In the pressure-sensitive adhesive tape of the present invention, it is important that the layers of the above lipophilic layered clay mineral be peeled and dispersed from each other to a sufficient extent before the use of the pressure-sensitive adhesive tape. In this description, the phrase “being peeled and dispersed” refers to a state where the layered clay mineral is peeled such that the superposed area of the silicate layers thereof reduces and the peeled product is dispersed, that is, dispersed into another substance (which may be one component or a mixture of multiple components). Any appropriate method can be adopted as a method of peeling and dispersing the layers. For example, ultrasonic peeling, high-pressure shear peeling, ultra-high speed stirring, or supercritical CO₂ stirring can be employed, because the methods allow one to peel and disperse the layers from each other without crushing the lipophilic layered clay mineral. Of those, the high-pressure shear peeling is preferred, because, in the case of using the high-pressure shear peeling, desirable peeling and dispersing can be performed by controlling the pressure of extrusion and the repeating times of the extrusion. The layers of the lipophilic layered clay mineral are preferably peeled to such an extent that six or less silicate layers of the layered clay mineral overlap each other on average. When the average exceeds six, the total surface area of the layered clay mineral reduces, and an interaction between the layered clay mineral and an organic component reduces, so the toughness of the pressure-sensitive adhesive may reduce. The average number of overlapping layers can be analyzed with an electron microscope (TEM).

In the pressure-sensitive adhesive tape of the present invention, it is important that the interlayer distance of the lipophilic layered clay mineral be 50 Å or more. The interlayer distance is preferably 50 to 1,000 Å and more preferably 60 to 250 Å. The interlayer distance can be determined from the peak value of an angle measured with an X-ray diffractometer (XRD). The interlayer distance can be calculated by the following equation (1). In the present invention, the value of the interlayer distance determined by the equation (1) is applied.

Y=88.27X−0.9997 (1)

Y: interlayer distance (Å)
X: peak angle (°) obtained with X-ray diffractometer

As an example, if 1.75 (°) is substituted in the peak angle X, the interlayer distance Y is about 50 (Å).

The content of the above lipophilic layered clay mineral is preferably 0.1 to 20 parts by weight, more preferably 0.5 to 20 parts by weight, or still more preferably 1 to 10 parts by weight with respect to 100 parts by weight of the acrylic pressure-sensitive composition or the silicone-based pressure-sensitive adhesive composition. When the content is less than 0.1 part by weight, an effect of the present invention may not be sufficiently exerted. When the content is larger than 20 parts by weight, the viscosity of the pressure-sensitive adhesive layer increases, so an external appearance when the pressure-sensitive adhesive tape is applied may reduce.

As the substrate, any appropriate substrate may be employed. Examples thereof include a polyethylene terephthalate (PET) film, a polyethylene naphthalate (PEN) film, a polyether sulfone (PES) film, a polyether imide (PEI) film, a polysulfone (PSF) film, a polyphenylene sulfide (PPS) film, a polyether ether ketone (PEEK) film, a polyarylate (PAR) film, an aramide film, a polyimide film, and a liquid crystal polymer (LCP) film. In view of heat resistance, a film formed of a polyimide material is preferred.

Any appropriate thickness can be adopted as the thickness of the substrate. The thickness is preferably 10 to 250 μm.

Any appropriate method can be adopted as a method of producing the pressure-sensitive adhesive tape of the present invention. For example, the following method is employed. First, an upper portion of any substrate is coated with the pressure-sensitive adhesive composition (acrylic pressure-sensitive adhesive composition, silicone-based pressure-sensitive adhesive composition, or the like) containing the above lipophilic layered clay mineral, and the pressure-sensitive adhesive composition is dried so that a pressure-sensitive adhesive sheet is produced. Several sheets are superimposed on each other to provide a laminated sheet, and the laminated sheet is formed on the substrate. Alternatively, the pressure-sensitive adhesive composition (acrylic pressure-sensitive adhesive composition, silicone-based pressure-sensitive adhesive composition, or the like) containing the lipophilic layered clay mineral can be formed into a pressure-sensitive adhesive tape by: forming the pressure-sensitive adhesive composition containing the lipophilic layered clay mineral on the substrate without applying any shear; and drying the pressure-sensitive adhesive composition.

In the pressure-sensitive adhesive tape of the present invention, a protective film may be used in order to protect the pressure-sensitive adhesive layer. Examples of the protective film include plastic films formed of polyvinyl chloride, a vinyl chloride copolymer, polyethylene terephthalate, polybutylene terephthalate, polyurethane, a vinyl ethylene acetate copolymer, an ionomer resin, a ethylene-(meth)acrylic acid copolymer, an ethylene-(meth)acrylate copolymer, polystyrene, polycarbonate, or the like, each of which is subjected to releasing treatment with a silicone-based, long-chain alkyl-based, fluorine-based, aliphatic amide-based, or silica-based releasing agent. In addition, as the film of the polyolefin resin base such as polyethylene, polypropylene, polybutene, polybutadiene, and polymethyl pentene has a releasing property even without using a releasing treatment agent, and hence, the film alone can be used as a protective film. The thickness of the protective film is preferably about 10 to 100 μm.

The pressure-sensitive adhesive tape of the present invention is applicable to any appropriate application. The pressure-sensitive adhesive tape is suitably used in applications where heat resistance and a cohesive strength are required such as: the production of electronic parts; structures; and automobiles. The pressure-sensitive adhesive tape is particularly suitably used in applications where peeling is needed such as the production of an electronic part, a semiconductor device, or an electronic part for, for example, a flat display such as an LCD or PDP because the pressure-sensitive adhesive tape does not cause a problem of pressure-sensitive adhesive residue upon peeling from an adherend.

### EXAMPLES

Hereinafter, the present invention is described more specifically by way of examples. However, the present invention is not limited by those examples. In addition, the terms “part (s)” in the examples refer to “part(s) by weight”.

### <Peeling and Dispersing Properties of Layered Clay Mineral in Pressure-Sensitive Adhesive Layer>

The peeling and dispersing properties of the layered clay mineral in the pressure-sensitive adhesive layer were confirmed with a transmission electron microscope (TEM).

∘: peeling and dispersing properties are good
x: peeling and dispersing properties are poor

### <Measurement of Interlayer Distance of Layered Clay Mineral in Pressure-Sensitive Adhesive Layer>

The interlayer distance of the layered clay mineral in the pressure-sensitive adhesive layer was confirmed by measuring the angle at degree of 1.5 to 10 with an X-ray diffractometer (XRD) manufactured by Rigaku Corporation.

### <Method for Evaluation for Pressure-Sensitive Adhesive Residue>

A pressure-sensitive adhesive tape was brought into press contact with and stuck to a stainless sheet by reciprocating a 2-kg roller once on the stainless sheet. After the test piece had been left to stand at 175° C. for 1 hour, the pressure-sensitive adhesive tape was peeled in the direction at 90° from the stainless sheet, and whether the pressure-sensitive adhesive tape could be peeled without leaving a pressure-sensitive adhesive residue on the stainless sheet was examined.

∘: The pressure-sensitive adhesive tape could be peeled favorably without leaving a pressure-sensitive adhesive residue.
x: A pressure-sensitive adhesive residue was present.

### Reference Example 1

### Production of Layered Clay Mineral-Dispersed Liquid

SOMASIF MAE. LUCENTITE SAN, and LUCENTITE SPN manufactured by CO-OP Chemical was used as a layered clay mineral. In addition, interlayer peeling was performed as a peeling approach by high-pressure shearing with a Nanomizer manufactured by YOSHIDA KIKAI CO., LTD., whereby a layered clay mineral-dispersed liquid was produced.

### Reference Example 2

### Preparation of Acrylic Pressure-Sensitive Adhesive Solution

An acrylic pressure-sensitive adhesive solution was prepared by uniformly mixing 2 parts of a polyisocyanate compound (manufactured by NIPPON POLYURETHANE INDUSTRY CO., LTD., trade name: Colonate L) and 0.6 part of an epoxy-based compound (manufactured by Mitsubishi Gas Chemical Company, Inc., trade name: TETRAD-C) in 100 parts of an acrylic polymer obtained from a monomer mixed liquid composed of 100 parts of butyl acrylate and 3 parts of acrylic acid.

### Example 1

The layered clay mineral-dispersed liquid produced in Reference Example 1 was blended into the acrylic pressure-sensitive adhesive solution prepared in Reference Example 2 so that the amount of the layered clay mineral “LUCENTITE SPN” might be 1 part with respect to 100 parts of the acrylic polymer of the acrylic pressure-sensitive adhesive solution. Then, the mixture was sufficiently stirred by the Nanomizer manufactured by YOSHIDA KIKAI CO., LTD., whereby a pressure-sensitive adhesive solution (1) was produced.

A polyimide film having a thickness of 25 μm (manufactured by DU PONT-TORAY CO., LTD., Kapton 100H) was coated with the pressure-sensitive adhesive solution (1) so that the pressure-sensitive adhesive layer had a thickness of 10 μm, followed by drying. Further, one surface of a polyester film (manufactured by Mitsubishi Polyester Film Corp., trade name: MRF 50, thickness 50 μm, width 250 mm) was treated with a silicone-based release agent. The silicone release-treated surface of the polyester film was stuck to the pressure-sensitive adhesive layer, whereby a pressure-sensitive adhesive tape (1) was produced.

By measurement with an XRD, the peak derived from the layered clay mineral was not confirmed at a degree of 10 or less.

The obtained pressure-sensitive adhesive tape (1) was evaluated for the interlayer distance, the peeling and dispersing properties, and the pressure-sensitive adhesive residue of the layered clay mineral. Table 1 shows the results.

### Example 2

An pressure-sensitive adhesive tape (2) was produced in the same way as in Example 1 except that 2.5 parts of a layered clay mineral “LUCENTITE SPN” were blended into 100 parts of an acrylic polymer of the acrylic pressure-sensitive adhesive solution prepared in Reference Example 2.

By measurement with an XRD, the peak derived from the layered clay mineral was not confirmed at a degree of 10 or less.

The obtained pressure-sensitive adhesive tape (2) was evaluated for the interlayer distance, the peeling and dispersing properties, and the pressure-sensitive adhesive residue of the layered clay mineral. Table 1 shows the results.

### Comparative Example 1

The layered clay mineral-dispersed liquid produced in Reference Example 1 was blended in 100 parts of an acrylic polymer of the acrylic pressure-sensitive adhesive solution prepared in Reference Example 2 so that the amount of the layered clay mineral (SOMASIF MAE) was 5 parts. The mixture was stirred with TK ROBOMICS manufactured by PRIMIX Corporation, whereby a pressure-sensitive adhesive solution (C1) was produced.

A polyimide film having a thickness of 25 μm (manufactured by DU PONT-TORAY CO., LTD., Kapton 100H) was coated with the pressure-sensitive adhesive solution (C1) so that the pressure-sensitive adhesive layer had a thickness of 10 μm, followed by drying. Further, one surface of a polyester film (manufactured by Mitsubishi Polyester Film Corp., trade name: MRF 50, thickness 50 μm, width 250 mm) was treated with a silicone-based release agent. The silicone release-treated surface of the polyester film was stuck to the pressure-sensitive adhesive layer, whereby a pressure-sensitive adhesive tape (Cl) was produced.

By measurement with an XRD, the peak derived from the layered clay mineral was confirmed at a degree of around 3.2.

The obtained pressure-sensitive adhesive tape (C1) was evaluated for the interlayer distance, the peeling and dispersing properties, and the pressure-sensitive adhesive residue of the layered clay mineral. Table 1 shows the results.

### Comparative Example 2

A pressure-sensitive adhesive tape (C2) was produced in the same way as in Comparative Example 1 except that Nanomizer manufactured by YOSHIDA KIKAI CO., LTD. was used instead of TK ROBOMICS manufactured by PRIMIX Corporation.

By measurement with an XRD, the peak derived from the layered clay mineral was confirmed at a degree of around 3.2.

The obtained pressure-sensitive adhesive tape (C2) was evaluated for the interlayer distance, the peeling and dispersing properties, and the pressure-sensitive adhesive residue of the layered clay mineral. Table 1 shows the results.

### Comparative Example 3

An pressure-sensitive adhesive tape (C3) was produced in the same way as in Example 1 except that 2.5 parts of a layered clay mineral “LUCENTITE SAN” were blended into 100 parts of an acrylic polymer of the acrylic pressure-sensitive adhesive solution prepared in Reference Example 2.

By measurement with an XRD, the peak derived from the layered clay mineral was confirmed at a degree of around 3.0.

The obtained pressure-sensitive adhesive tape (C3) was evaluated for the interlayer distance, the peeling and dispersing properties, and the pressure-sensitive adhesive residue of the layered clay mineral. Table 1 shows the results.

TABLE 1

| | | | Pressure- |
|---|---|---|---|
| | Interlayer | Peeling and dispersing | sensitive |
| | distance of layered | properties of layered | adhesive |
| | clay mineral | clay mineral | residue |
| Example 1 | 70 Å | ∘ | ∘ |
| Example 2 | 60 Å | ∘ | ∘ |
| Comparative | 27 Å | x | x |
| Example 1 | | | |
| Comparative | 27 Å | x | x |
| Example 2 | | | |
| Comparative | 29 Å | x | x |
| Example 3 | | | |

### INDUSTRIAL APPLICABILITY

The pressure-sensitive adhesive tape of the present invention is suitably used in applications where heat resistance and a cohesive strength are required such as: the production of electronic parts; the production of semiconductor devices each using a metal lead frame; structures; and automobiles. The pressure-sensitive adhesive tape is particularly suitably used in the production of an electronic part, a semiconductor device, or an electronic part for, for example, a flat display such as an LCD or PDP.

1. A pressure-sensitive adhesive tape comprising, on a substrate, a pressure-sensitive adhesive layer containing a lipophilic layered clay mineral, wherein the layered clay mineral is in a state of being peeled and dispersed, and the interlayer distance of the layered clay mineral is 50 Å or more.

2. A pressure-sensitive adhesive tape according to claim 1, wherein the layered clay mineral comprises a smectite-based clay mineral and/or a mica-based clay mineral.

3. A pressure-sensitive adhesive tape according to claim 1, wherein the pressure-sensitive adhesive layer comprises an acrylic pressure-sensitive adhesive composition formed of a monomer composition mainly composed of an alkyl (meth)acrylate ester of an alkyl alcohol having 4 to 14 carbon atoms.

4. A pressure-sensitive adhesive tape according to claim 3, wherein 0.1 to 20 parts by weight of the layered clay mineral are incorporated with respect to 100 parts by weight of the acrylic pressure-sensitive adhesive composition.

5. A pressure-sensitive adhesive tape according to claim 1, wherein the pressure-sensitive adhesive layer comprises a silicone-based pressure-sensitive adhesive composition.

6. A pressure-sensitive adhesive tape according to claim 5, wherein 0.1 to 20 parts by weight of the layered clay mineral are incorporated with respect to 100 parts by weight of the silicone-based pressure-sensitive adhesive composition.

7. A pressure-sensitive adhesive tape according to claim 1, wherein the pressure-sensitive adhesive tape is used in producing an electronic part.

8. A pressure-sensitive adhesive tape according to claim 2, wherein the pressure-sensitive adhesive layer comprises an acrylic pressure-sensitive adhesive composition formed of a monomer composition mainly composed of an alkyl (meth)acrylate ester of an alkyl alcohol having 4 to 14 carbon atoms.

9. A pressure-sensitive adhesive tape according to claim 2, wherein the pressure-sensitive adhesive layer comprises a silicone-based pressure-sensitive adhesive composition.

10. A pressure-sensitive adhesive tape according to claim 2, wherein the pressure-sensitive adhesive tape is used in producing an electronic part.

11. A pressure-sensitive adhesive tape according to claim 3, wherein the pressure-sensitive adhesive tape is used in producing an electronic part.

12. A pressure-sensitive adhesive tape according to claim 4, wherein the pressure-sensitive adhesive tape is used in producing an electronic part.

13. A pressure-sensitive adhesive tape according to claim 5, wherein the pressure-sensitive adhesive tape is used in producing an electronic part.

14. A pressure-sensitive adhesive tape according to claim 6, wherein the pressure-sensitive adhesive tape is used in producing an electronic part.
